(19) United States
(12) Patent Application Publication
(10) Pub. No.: US 2026/0202588 A1
(43) Pub. Date: Jul. 16, 2026

(54) LIGHT CONTROL FILM WITH RANDOM NANOSTRUCTURED ETCH STOP

(71) Applicant: 3M INNOVATIVE PROPERTIES COMPANY, St. Paul, MN (US)

(72) Inventors: Caleb T. Nelson, McKinney, TX (US); Benjamin J. Forsythe, Stillwater, MN (US); Timothy G. Gartmann, Baldwin, WI (US); Raymond J. Kenney, Woodbury, MN (US); Daniel J. Schmidt, Woodbury, MN (US); David S. Thompson, Bayport, MN (US)

(21) Appl. No.: 19/136,446

(22) PCT Filed: Dec. 5, 2023
(86) PCT No.: PCT/IB2023/062270

§ 371 Date: Jun. 6, 2025

Related U.S. Application Data
(60) Provisional application No. 63/431,373, filed on Dec. 9, 2022.

(51) Int. Cl. G02B 3/08

(52) U.S. Cl. CPC G02B 3/08

(57) ABSTRACT

A light control film includes a structured first major surface opposite a second major surface. The first major surface includes alternating first facets and second facets. Each of the first facets makes an average angle of less than 90 degrees with the second major surface. Each of the second facets makes an average angle of greater than 60 degrees with the second major surface. Each first facet is etched to form first nanostructured facets. Each of the first nanostructured facets includes nano-columns arranged across at least 70% of the first nanostructured facet. A coating layer coated on the first and second facets conforms to the nano-columns of the first nanostructured facets and has an average thickness of greater than 5 nm and less than 200 nm. A cover layer coated on coating layer portions corresponding to the second facets has an average thickness of greater than 0.05 microns.

### SUMMARY

In some aspects of the present description, a light control film is provided, the light control film including a structured first major surface opposite a second major surface. The structured first major surface includes a plurality of alternating first facets and second facets. Each of the first facets makes an average first angle of less than about 90 degrees with the second major surface, and each of the second facets makes an average second angle of greater than about 60 degrees with the second major surface. At least each of a plurality of the first facets is etched to form a plurality of first nanostructured facets. Each of the first nanostructured facets includes a plurality of nano-columns arranged across at least 70% of the first nanostructured facet. The nano-columns of the plurality of nano-columns have different heights and aspect ratios. A coating layer is substantially conformally coated on the first facets and the second facets so as to be substantially conforming to at least the nano-columns of the first nanostructured facets. The coating layer has an average thickness of greater than about 5 nm and less than about 200 nm. A cover layer is substantially conformally coated on, and covers at least 70% of, coating layer portions corresponding to the second facets. The cover layer has an average thickness of greater than about 0.05 microns.

In some aspects of the present description, a light control film is provided, the light control film including a light transmissive body having a structured first major surface and an opposite second major surface. The structured first major surface includes a plurality of alternating first and second facets. Each of the first facets makes an average first angle of less than about 90 degrees with the second major surface, and each of the second facets makes an average second angle of greater than about 60 degrees with the second major surface. At least each of a plurality of the first facets includes a plurality of nano-columns arranged across at least 70% of the first facet, and at least some of the nano-columns have aspect ratios greater than 1.5. A coating layer is substantially conformally coated on the first facets and the second facets so as to be substantially conforming to at least the nano-columns of the first facets. A cover layer is substantially conformally coated on, and covering at least 70% of, coating layer portions corresponding to the second facets. A planarizing overcoat conformally covers, and substantially planarizes, the structured first major surface. A minimum average peel strength between the planarizing overcoat and the coating layer is greater than about 20 μm/inch. For at least one visible wavelength in a visible wavelength range extending from about 420 nm to about 680 nm, a magnitude of a difference between indices of refraction of the light transmissive body and the planarizing overcoat is greater than about 0.05. For a light incident on the light control film from a CIE Standard Illuminant D65, the light control film has an optical haze of less than about 30%.

In some aspects of the present description, a light control film is provided, the light control film including a light transmissive body having a structured first major surface including a plurality of alternating first and second facets. Adjacent first and second facets make an inclusion angle of greater than about 5 degrees and less than about 150 degrees therebetween. A first coating layer is substantially conformally coated on the first and second facets and has an average thickness of greater than about 5 nm and less than about 200 nm. A cover layer is substantially conformally coated on, and covers at least 70% of, coating layer portions corresponding to the second facets. A planarizing overcoat conformally covers, and substantially planarizes, the structured first major surface. The light control film further includes a second coating layer disposed between the cover layer and the planarizing overcoat, The second coating layer has an average thickness of less than about 200 nm. The first and second coating layers include a same inorganic material.

In some aspects of the present description, a light control film is provided, the light control film including a light transmissive body having a structured first major surface including a plurality of alternating first and second facets. Adjacent first and second facets make an inclusion angle of greater than about 5 degrees therebetween. At least some of the first facets are nano-structured and include a plurality of nano-columns arranged thereacross. A coating layer is substantially conformally coated on at least some of the nano-structured first facets so as to be substantially conforming to at least the nano-columns of the nano-structured first facets. The coating layer has an average thickness of less than about 200 nm. A planarizing overcoat conformally covers, and substantially planarizes, the structured first major surface; In a plurality of spaced apart locations along at least the nano-structured first facets, elongated portions of the planarizing overcoat penetrate the nano-structured facets and into the light transmissive body.

In some aspects of the present description, a method of making a light control film is provided, the method of making a light control film including the steps of (a) providing a light transmissive body having a structured first major surface and an opposite second major surface, the structured first major surface including a plurality of alternating first and second facets, each of the first facets making an average first angle of less than about 90 degrees with the second major surface, each of the second facets making an average second angle of greater than about 60 degrees with the second major surface, (b) etching the structured first major to result in each of the first facets having a plurality of nano-columns arranged across at least 70% of the first facet, at least some of the nano-columns having aspect ratios greater than 1.5, (c) depositing a first material forming a coating layer substantially conformally coated on the first facets and the second facets so as to be substantially conforming to at least the nano-columns of the first facets, (d) depositing a light absorbing layer conformally on the coating layer, and (e) selectively substantially removing at least 70% of the light absorbing layer from the first facets while substantially leaving at least 70% of the light absorbing layer on the second facets.

### BRIEF DESCRIPTION OF THE DRAWINGS

FIGS. 1A and 1B provide side views of a light control film, in accordance with an embodiment of the present description;

FIG. 2 is a side view of a light control film, in accordance with an alternate embodiment of the present description;

FIG. 3 provides alternate views of a light control film, in accordance with an embodiment of the present description;

FIGS. 4A and 4B illustrate embodiments of a display system featuring a light control film, in accordance with an embodiment of the present description;

FIG. 5 includes close-up images detailing the layers of a light control film, in accordance with an embodiment of the present description;

FIG. 6 includes images of a light control film showing nanocolumn features, in accordance with an embodiment of the present description;

FIG. 7 is an image of a light control film showing elongated portions of a planarizing overcoat penetrating the nano-structured facets, in accordance with an embodiment of the present description;

FIG. 8 is another image of a light control film showing elongated portions penetrating the nano-structured facets, in accordance with an embodiment of the present description;

FIG. 9 details a method for making a light control film, in accordance with an embodiment of the present description; and

FIG. 10 provides a view of a light control film and substrate for use in a peel strength test, in accordance with an embodiment of the present description.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

Etch stop layers are often used in the semiconductor industry to precisely control the depth of reactive ion etching (RIE) processes. These layers are typically smooth, continuous layers deposited by a variety of vacuum processes, including physical vapor deposition (PVD), plasma-enhanced chemical vapor deposition (PECVD), and atomic layer deposition (ALD). The chemistry of the etch stop is chosen to obtain high etch selectivity in the layer being etched. The most common choices are inorganic thin layers.

Smooth inorganic surfaces are useful as etch stop layers, allowing RIE processes to selectively remove layers of material without etching into the underlying surface, which can add additional unwanted haze. However, in applications that require a backfilled resin, these smooth inorganic etch stop layers do not promote good adhesion.

Etch stop layers can also be used in optical films where patterning is required. In these cases, the thickness and optical constants of the etch stop layer also need to be considered. Maintaining thin layers is important when utilizing etch stop layers with any significant extinction coefficient or difference in refractive index with the adjacent layers. For these purposes, SiO2, TiO2, and AlO2 all provide excellent options. In these applications, the etch stop surface is maintained with minimal roughness in order to provide minimum thickness requirements and with little additional haze. However, smooth inorganic layers are difficult to bond to in cast and cure processes.

One method described herein of creating a light control film combines small random nanostructures with a continuous inorganic layer to substantially increase adhesion with overcoated resins without substantially adding haze. This method and the resulting article perform well on substrates with varying angles and aspect ratios like a Fresnel lens. However, these varying angles and aspect ratios receive different fluxes of free radicals and ions during plasma processing, which can make it difficult to achieve both nanostructures smaller than typical haze forming sizes while still maintaining good etch stop performance on all facets.

According to some aspects of the present description, a light control film having a nanostructured etch stop surface can provide robust etch stop performance, low haze, and increased adhesion to an overcoated resin. In some embodiments, the light control film may have a structured first major surface opposite a second major surface. In some embodiments, the structured first major surface may include a plurality of alternating first facets and second facets (e.g., the alternating facets of a Fresnel lens). In some embodiments, each of the first facets may make an average first angle, q1, of less than about 90 degrees, or less than about 85 degrees, or less than about 80 degrees, or less than about 75 degrees, or less than about 70 degrees, or less than about 65 degrees, or less than about 60 degrees, or less than about 55 degrees, or less than about 50 degrees, or less than about 45 degrees, or less than about 40 degrees, or less than about 35 degrees, or less than about 30 degrees, or less than about 25 degrees, or less than about 20 degrees, or less than about 15 degrees, or less than about 10 degrees, or less than about 5 degrees, or less than 3 degrees, or less than 1 degree with the second major surface. In some embodiments, each of the second facets may make an average second angle, θ2, of greater than about 60 degrees, or greater than about 65 degrees, or greater than about 70 degrees, or greater than about 75 degrees, or greater than about 80 degrees, or greater than about 85 degrees, or greater than about 90 degrees, or greater than about 95 degrees, or greater than about 96 degrees, or greater than about 97 degrees, or greater than about 98 degrees, or greater than about 99 degrees with the second major surface.

In some embodiments, at least each of a plurality of the first facets may be etched to form a plurality of first nanostructured facets. In some embodiments, each of the first nanostructured facets may include a plurality of features (e.g., nano-columns) arranged across at least 70%, or at least 75%, or at least 80%, or at least 85%, or at least 90%, or at least 95% of the first nanostructured facet. In some embodiments, each of the features may have different heights and aspect ratios (e.g., the ratio of height over width). In some embodiments, at least one of the first facets may not be etched and may not include any nano-columns.

In some embodiments, a coating layer (e.g., an etch stop layer) may be substantially conformally coated on the first facets and the second facets to be substantially conforming to at least the nano-columns of the first nanostructured facets. In some embodiments, the coating layer may have an average thickness of greater than about 5 nm, or greater than about 7.5 nm, or greater than about 10 nm, or greater than about 12.5 nm, or greater than about 15 nm, or greater than about 17.5 nm, or greater than about 20 nm and less than about 200 nm, or less than about 180 nm, or less than about 160 nm, or less than about 150 nm, or less than about 140 nm, or less than about 120 nm, or less than about 100 nm, or less than about 90 nm, or less than about 80 nm, or less than about 70 nm, or less than about 60 nm, or less than about 50 nm, or less than about 40 nm, or less than about 30 nm, or less than about 20 nm.

In some embodiments, a cover layer (e.g., a light absorbing layer) may be substantially conformally coated on, and cover at least 70%, or at least 75%, or at least 80%, or at least 85% or at least 90%, or at least 95% of, coating layer portions corresponding to the second facets. In some embodiments, the cover layer may have an average thickness of greater than about 0.05, or greater than about 0.1, or greater than about 0.15, or greater than about 0.2, or greater than about 0.25, or greater than about 0.3, or greater than about 0.35, or greater than about 0.4, or greater than about 0.45, or greater than about 0.5, or greater than about 0.55, or greater than about 0.6, or greater than about 0.65, or greater than about 0.7, or greater than about 0.75, or greater than about 1.0, or greater than about 1.25, or greater than about 1.5, or greater than about 2, or greater than about 2.5, or greater than about 3 microns.

In some embodiments, the cover layer may be deposited by layer-by-layer (LbL) deposition, sometimes referred to as LbL coating, LbL assembly, or LbL self-assembly. This coating method is based upon sequential, self-limiting adsorption of materials with complementary groups, and thus can provide substantially conformal coatings on structured surfaces. The complementary functional groups are most commonly positively-charged (e.g., amines) and negatively-charged (e.g., carboxylic acids, sulfonic acids, phosphonic acids) groups. Typical materials include polyelectrolyte polymers and/or nanoparticles such as surface-modified pigments (e.g., carbon black) or metal oxides. More details on LbL coating of a microstructured surface followed by selective removal of that coating via reactive ion etching (RIE) are provided in WO2019118685 (Schmidt et al.), incorporated herein by reference.

In some embodiments, at least 50%, or at least 60%, or at least 70%, or at least 80%, or at least 90% of the first facets of the structured first major surface may be curved. In some embodiments, at least 50%, or at least 60%, or at least 70%, or at least 80%, or at least 90% of the first facets may be substantially planar.

In some embodiments, the nanocolumns may have heights in a range from about 1 nm to about 1000 nm (e.g., between about 20 nm and about 500 nm). In some embodiments, the nanocolumns may have widths in a range from about 1 nm to about 1000 nm (e.g., between about 5 nm and about 100 nm). In some embodiments, a shape of a nanocolumn may be undercut, trapezoidal, upside-down trapezoidal, or pyramid, or any other appropriate shape. In some embodiments, at least one nano-column of at least one of the first nanostructured facets may have an aspect ratio greater than about 1.5, or greater than about 2, or greater than about 3, or greater than about 4, or greater than about 5, or greater than about 10, or greater than about 15.

In some embodiments, the cover layer may cover at most 40%, or at most 35%, or at most 30%, or at most 25%, or at most 20%, or at most 15%, or at most 10%, or at most 5% of the coating layers corresponding to the first nanostructured facets (e.g., the cover layer may be substantially removed from the first nanostructured facets). In some embodiments, the cover layer may be substantially light absorbing. In some such embodiments, the light absorbing cover layer may include a plurality of light absorbing particles. In some such embodiments, the light absorbing particles may include one or more of a dye, a pigment, a polyelectrolyte, and a carbon black. In some such embodiments, the light absorbing cover layer may have an optical density of greater than about 0.1, or greater than about 0.2, or greater than about 0.4, or greater than about 0.6, or greater than about 0.8, or greater than about 1, or greater than about 1.1, or greater than about 1.2, or greater than about 1.3, or greater than about 1.5, or greater than about 2, or greater than about 2.5, or greater than about 3, or greater than about 3.5, or greater than about 4, or greater than about 4.5, or greater than about 5, or greater than about 5.5, or greater than about 6.

In some embodiments, the light control film may further include a light transmissive body including the structured first major surface and the opposite second major surface. In some embodiments, the first and second facets may be substantially linear facets extending along a length direction (e.g., a y-axis) of the light control film and arranged along an orthogonal width direction (e.g., an x-axis) of the light control film.

In some embodiments, at least some of the first facets are curved. In some such embodiments, the structured first major surface may have a positive focal length for at least one visible wavelength in a visible (i.e., human-visible) wavelength range extending from about 420 nm to about 680 nm.

In some embodiments, the light control film may further include a planarizing overcoat which conformally covers, and substantially planarizes, the structured first major surface. In some such embodiments, a minimum average peel strength between the planarizing overcoat and the coating layer may be greater than about 20 μm/inch, or greater than about 50 μm/inch, or greater than about 100 gm/inch, or greater than about 250 μm/inch, or greater than about 500 μm/inch, or greater than about 750 gm/inch, or greater than about 1000 μm/inch. In some such embodiments, for a light incident on the light control film from a CIE Standard Illuminant D65, the light control film may have an optical haze of less than about 30%, or less than about 25%, or less than about 20%, or less than about 15%, or less than about 10%, or less than about 5%, or less than about 2.5%, or less than about 1%, or less than about 0.5%. In some such embodiments, the light control film may further include a light transmissive body comprising the structured first major surface and the opposite second major surface, and wherein for at least one visible wavelength in a visible wavelength range extending from about 420 nm to about 680 nm, a magnitude of a difference between indices of refraction of the light transmissive body and the planarizing overcoat may be greater than about 0.05, or greater than about 0.06, or greater than about 0.07, or greater than about 0.08, or greater than about 0.09, or greater than about 0.1, and less than about 0.5, or less than about 0.45, or less than about 0.4, or less than about 0.35, or less than about 0.3, or less than about 0.25.

In some embodiments, a display system may include any of the light control films of the present description disposed on a display (e.g., an LCD or LED display) configured to form an image, and a second light control film disposed between the light control film and the display. In some such embodiments, the second light control film may include a plurality of alternating substantially light transmissive and light absorbing regions. In some such embodiments, a first bonding layer (e.g., an adhesive) may bond the light control film to the second light control film, and a second bonding layer may bond the second light control film to the display. Alternatively, the bonding layer can be applied to the first light control film and bonded to a front surface, for example, a cover lens on the display.

According to some aspects of the present description, a light control film may include a light transmissive body having a structured first major surface and an opposite second major surface. In some embodiments, the structured first major surface may include a plurality of alternating first and second facets (e.g., the facets of a Fresnel lens surface).

In some embodiments, each of the first facets may make an average first angle θ1 of less than about 90, or less than about 85 degrees, or less than about 80 degrees, or less than about 75 degrees, or less than about 70 degrees, or less than about 65 degrees, or less than about 60 degrees, or less than about 55 degrees, or less than about 50 degrees, or less than about 45 degrees, or less than about 40 degrees, or less than about 35 degrees, or less than about 30 degrees, or less than about 25 degrees, or less than about 20 degrees, or less than about 15 degrees, or less than about 10 degrees, or less than about 5 degrees, or less than about 3 degrees, or less than about 1 degree with the second major surface. In some embodiments, each of the second facets may make an average second angle θ2 of greater than about 60 degrees, or greater than about 65 degrees, or greater than about 70 degrees, or greater than about 75 degrees, or greater than about 80 degrees, or greater than about 85 degrees, or greater than about 90 degrees, or greater than about 95 degrees, or greater than about 96 degrees, or greater than about 97 degrees, or greater than about 98 degrees, or greater than about 99 degrees with the second major surface.

In some embodiments, at least each of a plurality of the first facets may include a plurality of nano-columns (e.g., nanostructures or features) arranged across at least 70%, or at least 75%, or at least 80%, or at least 85%, or at least 95%, or at least 95% of the first facet. In some embodiments, at least some of the nano-columns may have aspect ratios greater than 1.5, or greater than 2, or greater than 3, or greater than 4, or greater than 5, or greater than 10, or greater than 15.

In some embodiments, at least two of the first facets in the plurality of the first facets that include nano-columns, have different nano-column densities. In some embodiments, at least two of the first facets in the plurality of the first facets that include nano-columns, have different nano-columns average aspect ratios.

In some embodiments, a coating layer (e.g., an etch stop layer) may be substantially conformally coated on the first facets and the second facets so as to be substantially conforming to at least the nano-columns of the first facets. In some embodiments, a cover layer (e.g., a light absorbing layer) may be substantially conformally coated on, and covering at least 70%, or at least 75%, or at least 80%, or at least 85% or at least 90%, or at least 95% of, coating layer portions corresponding to the second facets.

In some embodiments, a planarizing overcoat may conformally cover, and substantially planarize, the structured first major surface. In some such embodiments, a minimum average peel strength between the planarizing overcoat and the coating layer is greater than about 20 μm/inch, or greater than about 50 gm/inch, or greater than about 100 μm/inch, or greater than about 250 μm/inch, or greater than about 500 gm/inch, or greater than about 750 μm/inch, or greater than about 1000 μm/inch.

In some embodiments, for at least one visible wavelength in a visible wavelength range extending from about 420 nm to about 680 nm, a magnitude of a difference between indices of refraction of the light transmissive body and the planarizing overcoat is greater than about 0.05, or greater than about 0.06, or greater than about 0.07, or greater than about 0.08, or greater than about 0.09, or greater than about 0.1. In some embodiments, for a light incident on the light control film from a CIE Standard Illuminant D65, the light control film has an optical haze of less than about 30%, or less than about 25%, or less than about 20%, or less than about 15%, or less than about 10%, or less than about 5%, or less than about 2.5%, or less than about 1%, or less than about 0.5%.

According to some aspects of the present description, a light control film may include a light transmissive body having a structured first major surface including a plurality of alternating first and second facets. In some embodiments, adjacent first and second facets may make an inclusion angle θ3 of greater than about 5 degrees, or greater than about 10 degrees, or greater than about 15 degrees, or greater than about 20 degrees, or greater than about 25 degrees, or greater than about 30 degrees, and less than about 150 degrees, or less than about 140 degrees, or less than about 130 degrees, or less than about 120 degrees, or less than about 100 degrees therebetween.

In some embodiments, the light control film may further include a first coating layer (e.g., an etch stop layer) substantially conformally coated on the first and second facets and having an average thickness of greater than about 5 nm, or greater than about 7.5 nm, or greater than about 10 nm, or greater than about 12.5 nm, or greater than about 15 nm, or greater than about 17.5, or greater than about 20 nm, and less than about 200 nm, or less than about 180 nm, or less than about 160 nm, or less than about 150 nm, or less than about 140 nm, or less than about 120 nm, or less than about 100 nm, or less than about 90 nm, or less than about 80 nm, or less than about 70 nm, or less than about 60 nm, or less than about 50 nm, or less than about 40 nm, or less than about 30 nm, or less than about 20 nm.

In some embodiments, the light control film may further include a cover layer (e.g., a light absorbing layer) substantially conformally coated on, and covering at least 70%, or at least 75%, or at least 80%, or at least 85%, or at least 90%, or at least 95% of, coating layer portions corresponding to the second facets. In some embodiments, the cover layer may be substantially removed from the first facets.

In some embodiments, the light control film may further include a planarizing overcoat conformally covering, and substantially planarizing, the structured first major surface.

In some embodiments, the light control film may further include a second coating layer disposed between the cover layer and the planarizing overcoat and having an average thickness of less than about 200 nm, or less than about 180 nm, or less than about 160 nm, or less than about 150 nm, or less than about 140 nm, or less than about 120 nm, or less than about 100 nm, or less than about 90 nm, or less than about 80 nm, or less than about 70 nm, or less than about 60 nm, or less than about 50 nm, or less than about 40 nm, or less than about 30 nm, or less than about 20 nm. In some embodiments, the first and second coating layers may include a same inorganic material (e.g., silicon).

According to some aspects of the present description, a light control film may include a light transmissive body having a structured first major surface including a plurality of alternating first and second facets. In some embodiments, adjacent first and second facets may make an inclusion angle θ3 of greater than about 5 degrees, or greater than about 10 degrees, or greater than about 15 degrees, or greater than about 20 degrees, or greater than about 25 degrees, or greater than about 30 degrees, and less than about 150 degrees, or less than about 140 degrees, or less than about 130 degrees, or less than about 120 degrees, or less than about 100 degrees therebetween. In some embodiments, at least some of the first facets may be nano-structured and may include a plurality of nano-columns arranged thereacross.

In some embodiments, the light control film may further include a coating layer (e.g., an etch stop layer) substantially conformally coated on at least some of the nano-structured first facets so as to be substantially conforming to at least the nano-columns of the nano-structured first facets. In some such embodiments, the coating layer may have an average thickness of less than about 200 nm, or less than about 180 nm, or less than about 160 nm, or less than about 150 nm, or less than about 140 nm, or less than about 120 nm, or less than about 100 nm, or less than about 90 nm, or less than about 80 nm, or less than about 70 nm, or less than about 60 nm, or less than about 50 nm, or less than about 40 nm, or less than about 30 nm, or less than about 20 nm.

In some embodiments, the light control film may further include a planarizing overcoat conformally covering, and substantially planarizing, the structured first major surface. In some such embodiments, in a plurality of spaced apart locations along at least the nano-structured first facets, elongated portions of the planarizing overcoat may penetrate the nano-structured facets and into the light transmissive body. In some embodiments, at least some of the elongated portions may have a length greater than about 50 nm, or greater than about 100 nm, or greater than about 200 nm, or greater than about 500 nm, or greater than about 750 nm, or greater than about 1 micron, or greater than about 2 microns, or greater than about 3 microns, or greater than about 4 microns, or greater than about 5 microns, or greater than about 10 microns. In some embodiments, at least some of the elongated portions may extend along a direction that makes an angle θ4 of greater than about 5 degrees, or greater than about 10 degrees, or greater than about 15 degrees with a normal to the corresponding nano-structured first facets. In some embodiments, the elongated portions may correspond to a same nano-structured first facet and may be substantially parallel with each other.

According to some aspects of the present description, a method of making a light control film includes the steps of (a) providing a light transmissive body including a structured first major surface and an opposite second major surface, the structured first major surface including a plurality of alternating first and second facets, each of the first facets making an average first angle θ1 of less than about 90 degrees, or less than about 85 degrees, or less than about 80 degrees, or less than about 75 degrees, or less than about 70 degrees, or less than about 65 degrees, or less than about 60 degrees, or less than about 55 degrees, or less than about 50 degrees, or less than about 45 degrees, or less than about 40 degrees, or less than about 35 degrees, or less than about 30 degrees, or less than about 25 degrees, or less than about 20 degrees, or less than about 15 degrees, or less than about 10 degrees, or less than about 5 degrees, or less than about 3 degrees, or less than 1 degree with the second major surface, each of the second facets making an average second angle θ2 of greater than about 60 degrees, or greater than about 65 degrees, or greater than about 70 degrees, or greater than about 75 degrees, or greater than about 80 degrees, or greater than about 85 degrees, or greater than about 90 degrees, or greater than about 95 degrees, or greater than about 96 degrees, or greater than about 97 degrees, or greater than about 98 degrees, or greater than about 99 degrees with the second major surface, (b) etching the structured first major surface to result in each of the first facets having a plurality of nano-columns arranged across at least 70%, or at least 75%, or at least 80%, or at least 85%, or at least 90%, or at least 95% of the first facet, at least some of the nano-columns having aspect ratios greater than about 1.5, or greater than about 2, or greater than about 3, or greater than about 4, or greater than about 5, or greater than about 10, or greater than about 15, (c) depositing a first material forming a coating layer (e.g., an etch stop layer) substantially conformally coated on the first facets and the second facets so as to be substantially conforming to at least the nano-columns of the first facets, (d) depositing a light absorbing layer conformally on the coating layer, and (e) selectively substantially removing at least 70%, or at least 75%, or at least 80%, or at least 85% or at least 90%, or at least 95% of the light absorbing layer from the first facets while substantially leaving at least 70% of the light absorbing layer on the second facets.

In some embodiments, the method of making a light control film further includes depositing a mask layer on the structured major surface prior to etching the structured first major surface. That is, in some embodiments, a mask layer is first deposited before the etching step to facilitate the etching step. In some other embodiments, the deposition of the mask layer on the structured major surface and the etching of the structured first major surface are performed at substantially a same time.

In some embodiments, the method of making a light control film may further include (f) depositing conformally a planarizing overcoat which substantially planarizes the structured first major surface. In some such embodiments, a minimum average peel strength between the planarizing overcoat and the coating layer may be greater than about 20 μm/inch, or greater than about 50 μm/inch, or greater than about 100 μm/inch, or greater than about 250 μm/inch, or greater than about 500 μm/inch, or greater than about 750 μm/inch, or greater than about 1000 μm/inch.

In some embodiments, for a light incident on the light control film from a CIE Standard Illuminant D65, the light control film may have an optical haze of less than about 30%, or less than about 25%, or less than about 20%, or less than about 15%, or less than about 10%, or less than about 5%, or less than about 2.5%, or less than about 1%, or less than about 0.5%.

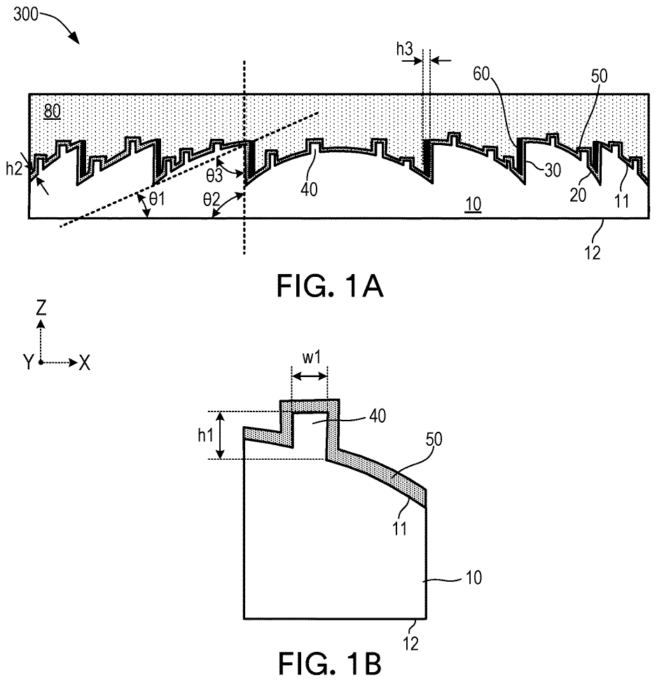

Turning now to the figures, FIGS. 1A and 1B provide side, cutaway views of an embodiment of a light control film according to the present description. FIG. 1B provides a closeup view of a portion of the light control film in FIG. 1A for the discussion of additional details. In some embodiments, light control film 300 includes a light transmissive body 10 having a structured first major surface 11 opposite a second major surface 12, a coating layer 50, and a cover layer 60. In some embodiments, light control film 300 may further include a planarizing overcoat 80 conformally covering, and substantially planarizing, the structured first major surface 11. In some embodiments, the structured first major surface 11 may include a plurality of alternating first facets 20 and second facets 30.

In some embodiments, each of the first facets 20 may make an average first angle θ1 of less than about 90 degrees, or less than about 85 degrees, or less than about 80 degrees, or less than about 75 degrees, or less than about 70 degrees, or less than about 65 degrees, or less than about 60 degrees, or less than about 55 degrees, or less than about 50 degrees, or less than about 45 degrees, or less than about 40 degrees, or less than about 35 degrees, or less than about 30 degrees, or less than about 25 degrees, or less than about 20 degrees, or less than about 15 degrees, or less than about 10 degrees, or less than about 5 degrees, or less than about 3 degrees, or less than about 1 degree with the second major surface. In some embodiments, each of the second facets may make an average second angle θ2 of greater than about 60 degrees, or greater than about 65 degrees, or greater than about 70 degrees, or greater than about 75 degrees, or greater than about 80 degrees, or greater than about 85 degrees, or greater than about 90 degrees, or greater than about 95 degrees, or greater than about 96 degrees, or greater than about 97 degrees, or greater than about 98 degrees, or greater than about 99 degrees with the second major surface. In some embodiments, adjacent first 20 and second 30 facets may make an inclusion angle θ3 of greater than about 5 degrees, or greater than about 10 degrees, or greater than about 15 degrees, or greater than about 20 degrees, or greater than about 25 degrees, or greater than about 30 degrees and less than about 150 degrees, or less than about 140 degrees, or less than about 130 degrees, or less than about 120 degrees, or less than about 100 degrees therebetween.

In some embodiments, at least each of a plurality of the first facets 20 may be etched to form a plurality of first nanostructured facets 20. In some embodiments, each of the first nanostructured facets 20 may include a plurality of nano-columns 40 arranged across at least 70%, or at least 75%, or at least 80%, or at least 85%, or at least 90%, or at least 95% of the first nanostructured facet 20. In some embodiments, nano-columns 40 may have different heights h1, different widths w1, and different aspect ratios h1/w1 (see FIG. 1B).

In some embodiments, coating layer 50 (e.g., an etch stop layer) may be substantially conformally coated on first facets/first nanostructured facets 20 and second facets 30 so as to be substantially conforming to at least nano-columns 40 of the first nanostructured facets 20. In some embodiments, the coating layer may have an average thickness h2 of greater than about 5 nm, or greater than about 7.5 nm, or greater than about 10 nm, or greater than about 12.5 nm, or greater than about 15 nm, or greater than about 17.5 nm, or greater than about 20 nm and less than about 200 nm, or less than about 180 nm, or less than about 160 nm, or less than about 150 nm, or less than about 140 nm, or less than about 120 nm, or less than about 100 nm, or less than about 90 nm, or less than about 80 nm, or less than about 70 nm, or less than about 60 nm, or less than about 50 nm, or less than about 40 nm, or less than about 30 nm, or less than about 20 nm.

In some embodiments, a cover layer 60 (e.g., a light absorbing layer) may be substantially conformally coated on, and covering at least 70%, or at least 75%, or at least 80%, or at least 85% or at least 90%, or at least 95% of coating layer portions corresponding to the second facets 30. In some embodiments, the cover layer 60 may have an average thickness h3 of greater than about 0.05 microns, or greater than about 0.1 microns, or greater than about 0.15 microns, or greater than about 0.2 microns, or greater than about 0.25 microns, or greater than about 0.3 microns, or greater than about 0.35 microns, or greater than about 0.4 microns, or greater than about 0.45 microns, or greater than about 0.5 microns, or greater than about 0.55 microns, or greater than about 0.6 microns, or greater than about 0.65 microns, or greater than about 0.7 microns, or greater than about 0.75 microns, or greater than about 1.0 microns, or greater than about 1.25 microns, or greater than about 1.5 microns, or greater than about 2 microns, or greater than about 2.5 microns, or greater than about 3 microns.

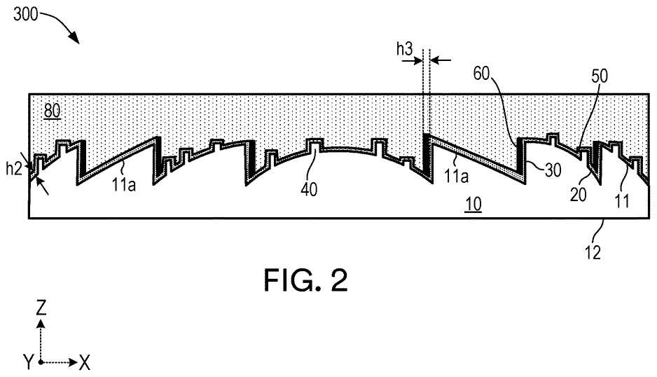

In some embodiments, wherein at least 60%, or at least 70%, or at least 80%, or at least 90%, or at least 95% of the second facets 30 are substantially planar. In some embodiments, at least 50%, or at least 60%, or at least 70%, or at least 80%, or at least 90% of the first facets 20 may be curved. In some embodiments, at least 50%, or at least 60%, or at least 70%, or at least 80%, or at least 90% of the first facets 11 (e.g., see first facets 11a of FIG. 2) may be substantially planar. In some embodiments, at least some of the first facets 20 may be curved so that the structured first major surface 11 has a positive focal length for at least one visible wavelength in a visible wavelength range extending from about 420 nm to about 680 nm.

In some embodiments, nanocolumns 40 may have heights h1 in a range from about 1 nm to about 1000 nm. In some embodiments, nanocolumns 40 may have heights h1 in a typical range of more than about 20 nm to less than 500 nm. In some embodiments, nanocolumns 40 may have widths w1 in a range from about 1 nm to about 1000 nm (typically about 5 nm less than 100 nm. In some embodiments, embodiments, nano-columns 40 may have undercuts. In some embodiments, nano-columns 40 may be rectangular prism, trapezoidal, upside-down trapezoidal, or pyramidal in shape. In some embodiments, at least one nano-column 40 of at least one of the first nanostructured facets 20 may have an aspect ratio greater than about 1.5, or greater than about 2, or greater than about 3, or greater than about 4, or greater than about 5, or greater than about 10, or greater than about 15. In some embodiments, at least two of the first facets 20 that include nano-columns 40 have different nano-column densities. In some embodiments, at least two of the first facets 20 that include nano-columns 40 have different nano-columns average aspect ratios.

In some embodiments, cover layer 60 may cover at most 40%, or at most 35%, or at most 30%, or at most 25%, or at most 20%, or at most 15%, or at most 10%, or at most 5% of the coating layers 50 corresponding to the first nanostructured facets 20. In some embodiments, cover layer 60 may be light absorbing. In some such embodiments, light absorbing cover layer 60 may include a plurality of light absorbing particles. In some such embodiments, the light absorbing particles may include one or more of a dye, a pigment, a polyelectrolyte, and a carbon black. In some embodiments, the light absorbing cover layer may have an optical density of greater than about 0.1, or greater than about 0.2, or greater than about 0.4, or greater than about 0.6, or greater than about 0.8, or greater than about 1, or greater than about 1.1, or greater than about 1.2, or greater than about 1.3, or greater than about 1.5, or greater than about 2, or greater than about 2.5, or greater than about 3, or greater than about 3.5, or greater than about 4, or greater than about 4.5, or greater than about 5, or greater than about 5.5, or greater than about 6.

In some embodiments, for at least one visible wavelength in a visible wavelength range extending from about 420 nm to about 680 nm, a magnitude of a difference between indices of refraction of the light transmissive body 10 and the planarizing overcoat 80 is greater than about 0.05, or greater than about 0.06, or greater than about 0.07, or greater than about 0.08, or greater than about 0.09, or greater than about 0.1 and less than about 0.5, or less than about 0.45, or less than about 0.4, or less than about 0.35, or less than about 0.3, or less than about 0.25. In some embodiments, for a light incident on the light control film from a CIE Standard Illuminant D65, the light control film 300 may have an optical haze of less than about 30%, or less than about 25%, or less than about 20%, or less than about 15%, or less than about 10%, or less than about 5%, or less than about 2.5%, or less than about 1%, or less than about 0.5%.

In some embodiments, a minimum average peel strength (when peeling in the y-direction as shown in FIG. 1A) between the planarizing overcoat 80 and the coating layer 50 may be greater than about 20 gm/inch, or greater than about 50 μm/inch, or greater than about 100 μm/inch, or greater than about 250 gm/inch, or greater than about 500 μm/inch, or greater than about 750 μm/inch, or greater than about 1000 gm/inch.

FIG. 2 is a side view of an alternate embodiment of light control film 300 of FIG. 1A. FIG. 2 shares several like-numbered elements with the embodiment of the light control film 300 of FIG. 1A, and, unless otherwise stated herein, these like-numbered elements are assumed to have the same function as their corresponding elements in FIG. 1A. The intent of FIG. 2 is to illustrate that, in some embodiments, some portion (i.e., at least 50%) of the first facets 20 may be substantially planar (see facets 11a). In some embodiments, at least one of the first facets 11a may not be etched and thereby does not include any nano-columns.

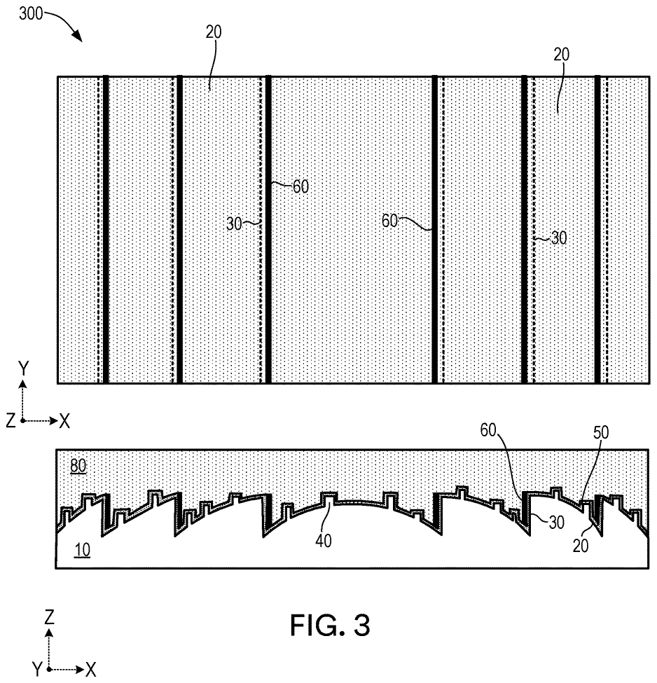

FIG. 3 provides alternate views of the embodiment of the light control film 300 of FIG. 1A. The upper portion of FIG. 3 shows a top, plan view of light control film 300 compared to the side view of the same film shown in the lower portion of FIG. 3. FIG. 3 shares several like-numbered elements with the embodiment of the light control film 300 of FIG. 1A, and, unless otherwise stated herein, these like-numbered elements are assumed to have the same function as their corresponding elements in FIG. 1A. In some embodiments, the first 20 and second 30 facets may be linear facets extending along a length direction (e.g., the y-axis shown in the upper portion of FIG. 3) of light control film 300 and arranged along an orthogonal width direction (e.g., the x-axis shown in the upper portion of FIG. 3) of light control film 300.

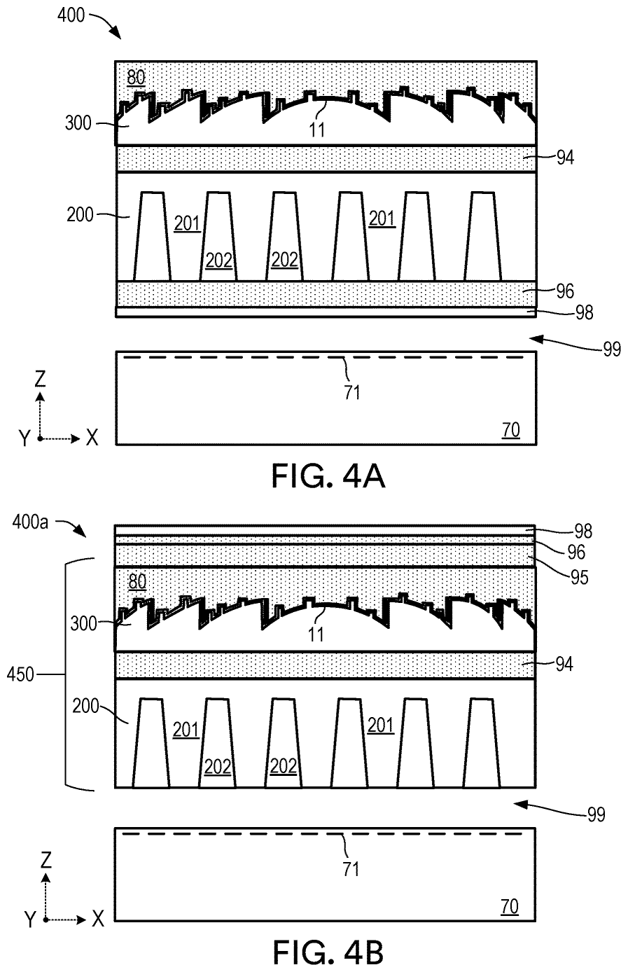

FIGS. 4A and 4B illustrate embodiments of a display system featuring an embodiment of a light control film according to the present description. Starting with FIG. 4A, in some embodiments, display system 400 may include any of embodiments of the light control film 300 described herein disposed on a display 70 configured to form an image 71, and a second light control film 200 (e.g., a louver film) disposed between the light control film 300 and display 70. In some embodiments, second light control film 200 may include a plurality of alternating substantially light transmissive 201 and light absorbing 202 regions. In some embodiments, a first bonding layer 94 bonds light control film 300 to second light control film 200, and a second bonding layer 96 bonds second light control film 200 to display 70. In some embodiments, second bonding layer 96 may bond second light control film 200 to a part of display 70, such as a cover lens 98. In some such embodiments, there may be an air gap 99 between the cover lens 98 and display 70.

In the embodiment shown in FIG. 4A, the light control film 300 is disposed on a side of cover lens 98 facing away from display 70. In the alternate embodiment of display system 400a shown in FIG. 4B, the light control film 300 may be disposed beneath cover lens 98, on a side of cover lens 98 facing toward display 70. In this embodiment, air gap 99 may be disposed between display 70 and second light control film 200. In this embodiment, bonding layer 96 (e.g., an optically clear adhesive) may bond light control film 300 to cover lens 98. The planarizing layer 80 of light control film 300 may include a substrate 95.

When planarizing layer 80 is disposed between the structured first major surface 11 of light control film 300 and substrate 95 as shown in FIG. 4B, the adhesion between the structured first major surface 11 and planarization layer 80 can be tested using the film assembly 450 using a 90-degree peel test such as that described in ASTM D6862-11 (2021) with some modifications. A strip of dimension 25 mm×800 mm of the film assembly 450 can be cut in a direction parallel with the linear prism direction. The substrate 95 can be attached to a rigid plate with 3M 410 double sided tape, where the adhesive side of the tape is applied to a rigid plate. The liner of the 410 tape can be removed and the substrate surface 95 can be adhered to the 410 tape. The louver side of the film is scored to initiate the peel at the interface between structured first major surface 11 and planarizing layer 80. An inch section of the louver side is placed into the test machine jaws or clamps. The test is run with a 10-pound load cell and a constant crosshead speed of 10 in/min.

It should be noted that FIGS. 4A and 4B are schematic drawings provided to show the order and placement of layers of possible embodiments of a display system and are not intended to be accurate with regard to layer thickness and component sizing. In addition, a display system may include other layers not shown in FIGS. 4A and 4B, and that other embodiments are possible which may have other arrangements of the layers shown, or which include alternate embodiments of some or all of the layers.

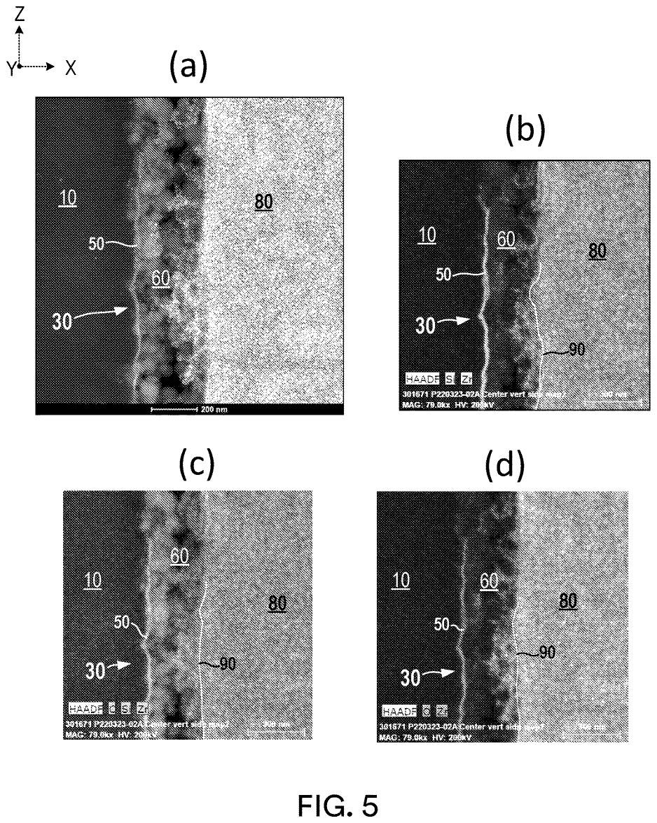

FIG. 5 includes closeup images detailing the layers of an embodiment of a light control film according to the present description. FIG. 5(a)-5(d) show various closeup images of a physical sample of the light control film 300 of FIG. 1A and other figures herein. The orientation of the images, it should be noted, is the same as the illustrations in FIGS. 1A-1B (see XYZ coordinate system reference in FIG. 5), but the images are focused on one of the second facets 30 which, in this example, is substantially vertical. As shown in FIG. 5(a), starting on the left of the image, the elements of the light control film are light transmissive body 10, a first coating layer 50 (e.g., an etch stop layer), a cover layer 60, and a planarizing overcoat 80. In some embodiments, as is shown in FIG. 5(b), (c), and (d), the light control film may further include a second coating layer 90 disposed between cover layer 60 and planarizing overcoat 80. (It should be noted that images in FIG. 5(b), (c), and (d) have been augmented with graphics better showing second coating layer 90, which did not show well in the black and white images used herein. In some embodiments, second coating layer 90 may have an average thickness of less than about 200 nm, or less than about 180 nm, or less than about 160 nm, or less than about 150 nm, or less than about 140 nm, or less than about 120 nm, or less than about 100 nm, or less than about 90 nm, or less than about 80 nm, or less than about 70 nm, or less than about 60 nm, or less than about 50 nm, or less than about 40 nm, or less than about 30 nm, or less than about 20 nm. In some embodiments, the first 50 and second 90 coating layers may include a same inorganic material (e.g., silicon). In some embodiments, second coating layer 90 may cover only a portion of the interface between cover layer 60 and planarizing layer 80.

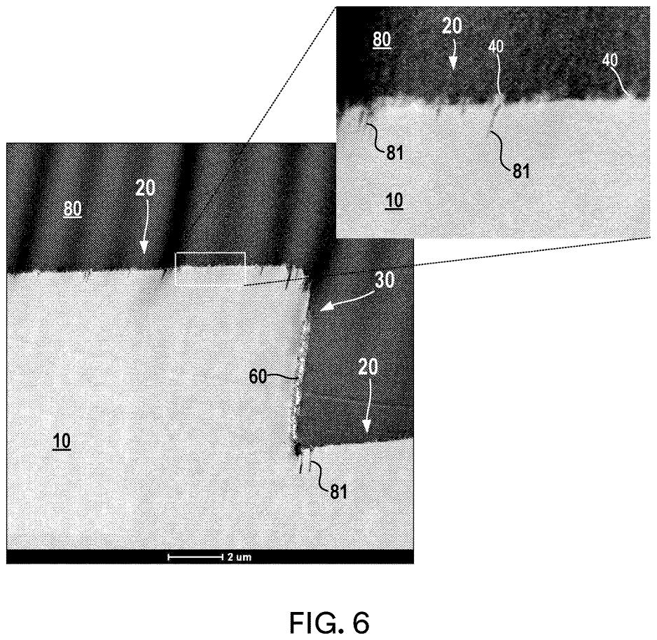

FIGS. 6, 7, and 8 includes images of an embodiment of a light control film showing nanocolumn features according to the present description. Specifically, these figures illustrate how elongated portions of planarizing overcoat 80 may penetrate into nano-structured facets 20 and into light transmissive body 10. FIG. 6 shows an image of a cross-section of a light control film according to an embodiment of the present disclosure. The smaller image is a closer view of the portion of the larger image indicated by the rectangular box on the larger image. The larger image shows a first facet 20 and second facet 30 of a light transmissive body 10. A cover layer 60 is shown substantially covering second facet 30 but substantially not covering first facet 20. The first facet 20 and second facet 30 are covered by a planarizing overcoat layer 80. As shown in the closeup image, first facet 20 may include a plurality of nano-column features 40.

In some embodiments, in a plurality of spaced apart locations along at least the nano-structured first facets 20, elongated portions 81 of planarizing overcoat 80 may penetrate the nano-structured facets 20 and into light transmissive body 10. In some embodiments, at least some of the elongated portions 81 may have a length greater than about 50 nm, or greater than about 100 nm, or greater than about 200 nm, or greater than about 500 nm, or greater than about 750 nm, or greater than about 1 micron, or greater than about 2 microns, or greater than about 3 microns, or greater than about 4 microns, or greater than about 5 microns, or greater than about 10 microns.

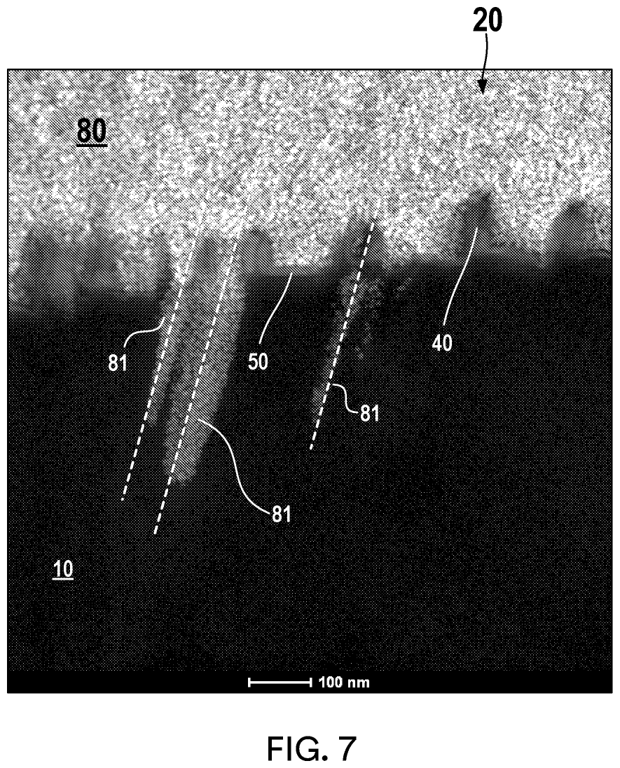

FIG. 7 provides an even closer image of the surface of first facet 20, where coating layer 50 is more readily visible between light transmissive body 10 and planarizing overcoat 80. In some embodiments, the elongated portions 81 corresponding to a same nano-structured first facet 20 may be substantially parallel with each other (as shown by the dashed lined augmenting the image of FIG. 7).

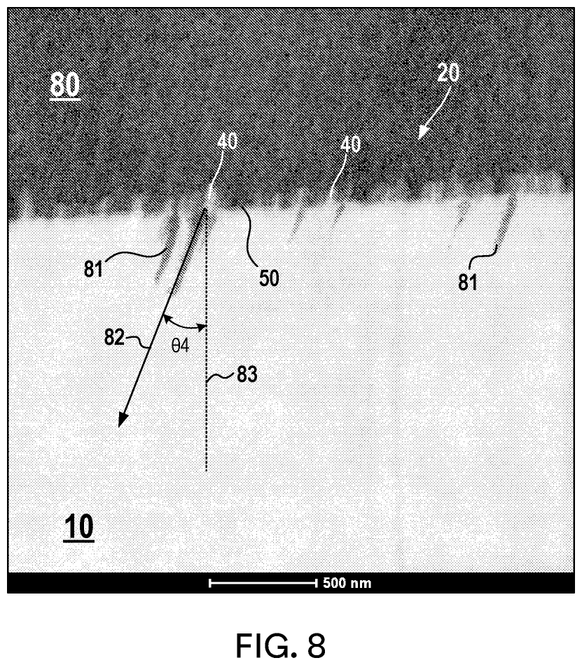

FIG. 8 is an additional image of a first facet 20 showing elongated portions 81 penetrating into light transmissive body 10. In some embodiments, at least some of elongated portions 81 extend along a direction 82 that makes an angle θ4 of greater than about 5 degrees, or greater than about 10 degrees, or greater than about 15 degrees with a normal 83 to the corresponding nano-structured first facets 20.

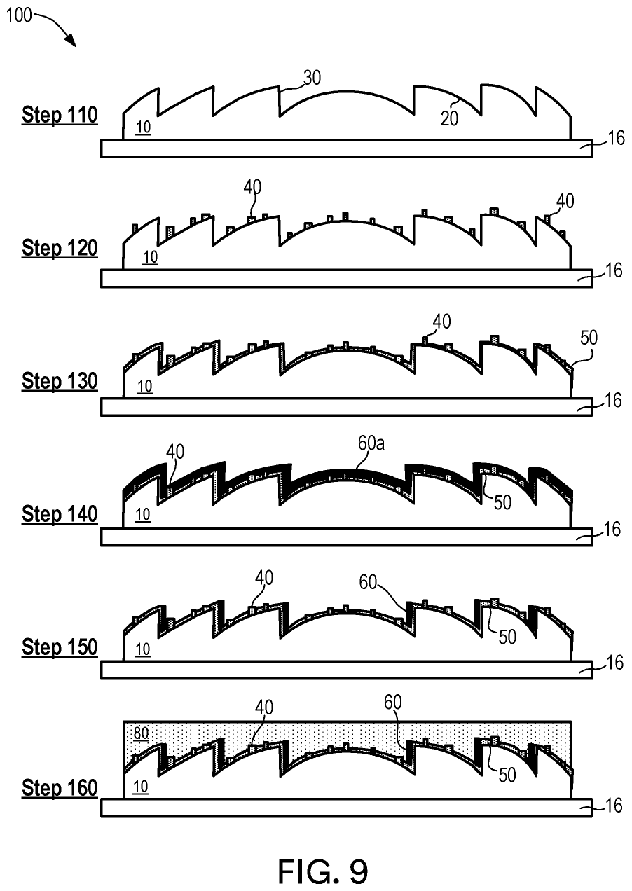

FIG. 9 details one method for making an embodiment of a light control film, such as light control film of FIG. 1A and other figures herein. In some embodiments, a method of making a light control film 100 includes the steps shown in FIG. 9. Step 110 involves providing a light transmissive body including a structured first major surface having a plurality of alternating first 20 and second 30 facets (such as light transmissive body 10 of FIG. 1). In some embodiments, Step 110 may include providing the light transmissive body on a substrate 16.

Step 120 includes etching the structured first major surface of light transmissive body 10 to result in each of the first facets 20 of light transmissive body 10 comprising a plurality of nano-columns 40 arranged across at least 70% of the first facet.

In some embodiments, Step 120 may include the deposition of a mask layer prior to the etching of the structured first major surface. In some such embodiments, the deposition of the mask layer and the etching of the structured first major surface may happen substantially simultaneously.

In Step 130, a first material is deposited on the structured major surface to form a coating layer 50 (e.g., an etch stop layer) substantially conformally coated on the first facets 20 and the second facets 30 so as to be substantially conforming to at least the nano-columns 40 of the first facets 20.

In Step 140, a light absorbing layer 60 is deposited conformally on the coating layer 50.

In Step 150, at least 70% of light absorbing layer 60 is removed from the first facets 20 while at least 70% of light absorbing layer 60 is left on the second facets 30.

In some embodiments, the method of making a light control film 100 may further Step 160 which includes depositing conformally a planarizing overcoat 80 which substantially planarizes the structured first major surface of light transmissive body 10.

In some embodiments, the method of making a light control film 100 produces a minimum average peel strength between the planarizing overcoat and the coating layer is greater than about 20 μm/inch. In some embodiments, for a light incident on the light control film from a CIE Standard Illuminant D65, the light control film has an optical haze of less than about 30%.

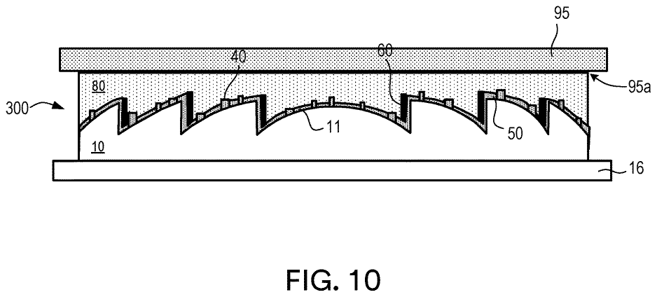

Finally, FIG. 10 is provided for the following discussion of Examples and shows a planarizing layer 80 disposed between the structured first major surface 11 of light control film 300 and a substrate 95. The adhesion between the light control film 300 and planarization layer 80 can be tested using the assembly the peel test procedure described elsewhere herein. In some embodiments, the peel test shows that the assembly shown in FIG. 10 fails at interface 95a between substrate 95 and planarizing layer 80, rather than between planarizing layer 80 and the structured first major surface 11 of light control film 300.

### EXAMPLES

Unless otherwise noted, all parts, percentages, ratios, etc. in the Examples and the rest of the specification are by weight.

| Abbreviation | Description |
|---|---|
| PU2560 | Aliphatic urethane difunctional acrylate oligomer from Miwon Specialty |
| | Chemical |
| M210 | Hydroxy pivalic acid neopentyl glycol diacrylate [HPNDA] from Miwon |
| | Specialty Chemical |
| Omnirad | Photoinitiator - blend of 2,4,6-trimethylbenzoyl-diphenyl-phosphine |
| 4265 | oxide (50%) and 2-hydroxy-2-methyl-1-phenylpropanone (50%), |
| | obtained under the trade designation “OMNIRAD 4265” from IGM |
| | Resins USA, Inc., Charlotte, NC |
| O2 | Oxygen gas (UHP compressed) obtained from Oxygen Service |
| | Company, St. Paul, MN |
| HMDSO | Hexamethyldisiloxane obtained from Gelest Inc., Morrisville, PA |
| SC72 | Cationic polyurethane dispersion, obtained under the trade designation |
| | “SANCURE 20072” from Lubrizol Corp., Wickliffe, OH |
| EXPCB | Anionic, surface-modified carbon black dispersion obtained from Cabot |
| | Corp., Boston, MA |
| NaCl | Sodium chloride, obtained as a 25% solids solution in water from Univar |
| | Solutions, Houston, TX |
| PL92 | Non-ionic surfactant, obtained under the trade designation, “PLURONIC |
| | L-92” from BASF Corp., Florham Park, NJ |
| Resin A | Formulation similar to those in U.S. Pat. No. 9,360,591. |

### Method for Cast-and-Cure Microreplication to Make Fresnel Lens Film

A diamond was used to cut a tool having a co-planar, microscale Fresnel lens structure. Resin B was prepared by mixing the materials in Table 1 below.

TABLE 1
Composition of Resin B Used to Make Microstructured Film

| Material | Parts by Weight |
|---|---|
| PU2560 | 49.50 |
| M210 | 49.50 |
| Omnirad 4265 | 1.00 |

A “cast-and-cure” microreplication process was carried out with Resin B and the tool described above on a continuous cast and cure microreplication line. Resin B was heated to 100° F. and coated onto a PET film with micro-louvers on the opposite side. The louvers were protected by a PP premask. The die temperature at coating was 100° F. After coating, the coated film passed under IR heaters at 130° F. The coated film then passed between a rubber nip roll and Fresnel lens tool at a nip pressure of 18 psi and tool temp of 130° F. The resulting film was cured using three sequential banks of Fusion D lamps at 100%, 60%, and 60% power, respectively.

### Method to Form Random Nanostructure

The surface of the microreplicated film was modified using a home-built parallel plate capacitively coupled plasma reactor as described in U.S. Pat. No. 6,696,157 (David et al.) with a single pass random nanostructure process as described in U.S. Pat. No. 10,134,566 (David, et al). The chamber has a central cylindrical powered electrode with a surface area of 18.3 ft². After placing the microreplicated film on the powered electrode, the reactor chamber was pumped down to a base pressure of less than 1.3 Pa (2 mTorr). O₂ and HMDSO gasses were flowed into the chamber at rates of 750 SCCM and 14 SCCM, respectively. Treatment was carried out using a plasma enhanced CVD method by coupling RF power into the reactor at a frequency of 13.56 MHz and an applied power. The film was moved through the reaction zone at a rate of 7.5 fpm, resulting in an approximate treatment time of 40 seconds. After completing the process, RF power was turned off and the chamber was returned to atmospheric pressure.

### Method to Coat an Inorganic Etch Stop (“Coating Layer”)

A silicon containing etch resist was deposited using a home-built parallel plate capacitively coupled plasma reactor as described in U.S. Pat. No. 6,696,157 (David et al.). The chamber has a central cylindrical powered electrode with a surface area of 18.3 ft². After placing the nanostructured tooling film on the powered electrode, the reactor chamber was pumped down to a base pressure of less than 1.3 Pa (2 mTorr). O₂ and HMDSO gasses were flowed into the chamber at rates of 1500 SCCM and 300 SCCM, respectively. Treatment was carried out using a plasma enhanced CVD method by coupling RF power into the reactor at a frequency of 13.56 MHz and an applied power of 7500 Watts. The film was moved through the reaction zone at a rate of 20 feet per minute, resulting in an approximate treatment time of 15 seconds. After completing the deposition, RF power was turned off and the chamber was returned to atmospheric pressure.

### Method to Coat a Light Absorbing Layer (“Cover Layer”)

A black, light-absorbing coating was coated conformally on the Fresnel lens film via layer-by-layer (LbL) deposition on a coater as described in U.S. Pat. No. 10,926,289 (Kawakami et al.). Two separate coating solutions were prepared: Cation and Anion. The Cation solution was 2.5% solids SC72 with 200 mM NaCl and 0.1% PL92 in de-ionized (DI) water. The Anion solution was 2.5% solids EXPCB with 50 mM NaCl and 0.1% PL92 in DI water. The light-absorbing coating construction comprised six bilayers, denoted as (SC72/EXPCB) 6. Microstructured film was threaded through the coating line. The Cation and Anion solutions were separately coated onto the microstructured film with a #4 Mayer Rod fed with needles from a liquid delivery manifold at a flow rate of about 200 mL/min at each coating station. Excess coating solution was removed from the web after each deposition step with air-knives gapped at 40 mil to the web with pressure of about 35 psi. Line speed was 50 feet per minute. Thickness of the LbL coating, determined by analyzing SEM and TEM images with ImageJ software, ranged from about 250-400 nm.

Method to Selectively Remove portions of the Light Absorbing Coating

Reactive ion etching was carried out on the coated film from step (4) in the same home-built reactor chamber used to deposit the PECVD release layer to create nanostructure and etch stop layers. After placing the coated film on the powered electrode, the reactor chamber was pumped down to a base pressure of less than 1.3 Pa (1 mTorr). O₂ gas was flowed into the chamber at a rate of 1000 SCCM. 13.56 MHz RF power was subsequently coupled into the reactor with an applied power of 9000 W. The film was then carried through the reaction zone at a rate of 1.5 ft/min, to achieve an exposure time of approximately 200 sec. At the end of this treatment time, the RF power and the gas supply were stopped, and the chamber was returned to atmospheric pressure.

### Method to Backfill

Resin A at 100° F. was coated on the primed side of 2-mil PET with PP premask laminated to the backside of the PET at 30 fpm. The coating die temperature was also 100° F. Prior to lamination, the film passed under IR heaters at 120° F. The structured film was brought in from a separate unwind and laminated to the coated PET film in a steel-rubber nip. The steel roll was heated to 140° F., rubber roll was unheated.

While held against the steel roll, the laminate was then UV cured using two banks of Fusion D bulbs, each at 60% power. A takeaway nip was used to remove the cured laminate from the steel roll.

### Method for Measuring Peel Strength

When a planarizing layer 80 is disposed between the structured first major surface 11 of light control film 300 and substrate 95 as shown in FIG. 10, the adhesion between the light control film 300 and planarization layer 80 can be tested using the assembly 450 using a 90-degree peel test such as that described in ASTM D6862-11(2021) with some modifications. A strip of dimension 25 mm×800 mm of the film 450 can be cut in a direction parallel with the linear prism direction. The substrate 95 can be attached to a rigid plate with 3M 665 double sided tape, where the adhesive side of the tape is applied to a rigid plate and the substrate surface 99 can be adhered to the 665 tape. The louver side of the film is scored to initiate the peel at the interface between the structured first major surface 11 of light control film 300 and planarizing layer 80. 3M 396 tape is then aligned with the substrate and rigid plate. The testing machine used was an Imass 2100. An inch section of the louver side is placed into the test machine jaws or clamps. The test is run with a 10 lb load cell and a constant crosshead speed of 10 in/min for a 5-second average of data collection.

### Method for Acquiring Scanning Electron Microscopy (SEM) Images

Samples were freeze fractured with liquid nitrogen. Imaging was done with a Hitachi S4700 Field Emission microscope. Images in this document are taken from the center of the Fresnel lens after delaminating the backfill resin

### Method for Acquiring Transmission Electron Microscopy (TEM) Images

Samples for TEM analysis were room-temperature ultra-microtomed. Cut thickness ranged between 100 and 130 nm. Microtomy-cut direction was chosen to be parallel or nearly parallel to a majority of the interfaces. TEM analysis was performed on a FEI-Osiris TEM, operating at 200 kV. The STEM imaging mode was used. Bright Field (BF), Dark Field (DF), and High Angle Annular Dark Field (HAADF) images were acquired. X-ray microanalysis was performed using a Bruker Super-X quad x-ray SDD (silicon drift detector) and accompanying Espirit quantitative analysis software system.

### CE1 No Etch Stop

Step 1: A microstructured film was prepared as described in “Method for Cast-and-Cure Microreplication to Make Fresnel Lens Film.”
Step 2: The microstructured film was coated with a light absorbing LBL layer as described in “Method to Coat a Light Absorbing Layer.”
Step 3: The light absorbing layer was etched as described in “Method to Selectively Remove the Light Absorbing Coating.”
Step 4: The structured film of Step 3 was backfilled as described in “Method to Backfill.” Peel values and haze measurements are recorded in Table 2.

### CE2 Planar Etch Stop

Step 1: A microstructured film was prepared as described in “Method for Cast-and-Cure Microreplication to Make Fresnel Lens Film.”
Step 2: An inorganic etch stop was applied the microstructured film as described in “Method to Coat an Inorganic Etch Stop.”
Step 3: The microstructured film was coated with a light absorbing LBL layer as described in “Method to Coat a Light Absorbing Layer.”
Step 4: The light absorbing layer was etched as described in “Method to Selectively Remove the Light Absorbing Coating.”
Step 5: The structured film of Step 4 was backfilled as described in “Method to Backfill.”
Peel values and haze measurements are recorded in Table 2.

### EX 1 Structured Etch Stop

Step 1: A microstructured film was prepared as described in “Method for Cast-and-Cure Microreplication to Make Fresnel Lens Film.”
Step 2: Nanostructure was formed on the surface of the structured film from Step 1 as described in the “Method to form Random Nanostructure.”
Step 3: An inorganic etch stop was applied the microstructured film as described in “Method to Coat an Inorganic Etch Stop.”
Step 4: The microstructured film was coated with a light absorbing LBL layer as described in “Method to Coat a Light Absorbing Layer.”
Step 5: The light absorbing layer was etched as described in “Method to Selectively Remove the Light Absorbing Coating.”
Step 6: The structured film of Step 4 was backfilled as described in “Method to Backfill.”
Peel values and haze measurements are recorded in Table 2.

TABLE 2
Example Conditions, Peel Values and Visual Grading

| Patent | 90° DW Peel, | | Haze |
|---|---|---|---|
| Example | grams/inch | | (Center |
| ID | width | RMS | of Lens) |
| CE 1 | 999 | 0 | 36.5% |
| CE 2 | 2 | 1 | 13.6% |
| Ex1 | 438 | 119.3 | 14.5% |

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially equal” is not otherwise clear to one of ordinary skill in the art in the context in which it is used and described in the present description, “substantially equal” will mean about equal where about is as described above. If the use of “substantially parallel” is not otherwise clear to one of ordinary skill in the art in the context in which it is used and described in the present description, “substantially parallel” will mean within 30 degrees of parallel. Directions or surfaces described as substantially parallel to one another may, in some embodiments, be within 20 degrees, or within 10 degrees of parallel, or may be parallel or nominally parallel. If the use of “substantially aligned” is not otherwise clear to one of ordinary skill in the art in the context in which it is used and described in the present description, “substantially aligned” will mean aligned to within 20% of a width of the objects being aligned. Objects described as substantially aligned may, in some embodiments, be aligned to within 10% or to within 5% of a width of the objects being aligned.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

What is claimed:

1. A light control film comprising a structured first major surface opposite a second major surface, the structured first major surface comprising a plurality of alternating first facets and second facets,
each of the first facets making an average first angle of less than about 90 degrees with the second major surface, each of the second facets making an average second angle of greater than about 60 degrees with the second major surface,
at least each of a plurality of the first facets etched to form a plurality of first nanostructured facets, each of the first nanostructured facets comprising a plurality of nano-columns arranged across at least 70% of the first nanostructured facet and having different heights and aspect ratios;
a coating layer substantially conformally coated on the first facets and the second facets so as to be substantially conforming to at least the nano-columns of the first nanostructured facets, the coating layer having an average thickness of greater than about 5 nm and less than about 200 nm; and
a cover layer substantially conformally coated on, and covering at least 70% of, coating layer portions corresponding to the second facets, the cover layer having an average thickness of greater than about 0.05 microns.

2. The light control film of claim 1, wherein at least 50% of the first facets are curved.

3. The light control film of claim 1, wherein at least 50% of the first facets are substantially planar.

4. The light control film of claim 1, wherein at least 60% of the second facets are substantially planar.

5. The light control film of claim 1, wherein the nanocolumns have heights in a range from about 1 nm to about 1000 nm.

6. The light control film of claim 1, wherein the nanocolumns have widths in a range from about 1 nm to about 1000 nm.

7. The light control film of claim 1, wherein at least one nano-column of at least one of the first nanostructured facets has an aspect ratio greater than 1.5.

8. The light control film of claim 1, wherein the cover layer covers at most 40% of the coating layers corresponding to the first nanostructured facets.

9. The light control film of claim 1, wherein the cover layer is light absorbing.

10. The light control film of claim 9, wherein the light absorbing cover layer comprises a plurality of light absorbing particles.

11. The light control film of claim 10, wherein the light absorbing particles comprise one or more of a dye, a pigment, a polyelectrolyte, and a carbon black.

12. The light control film of claim 9, wherein the light absorbing cover layer has an optical density of greater than about 0.1.

13. The light control film of claim 1 further comprising a light transmissive body comprising the structured first major surface and the opposite second major surface.

14. The light control film of claim 1, wherein the first and second facets are linear facets extending along a length direction of the light control film and arranged along an orthogonal width direction of the light control film.

15. The light control film of claim 1, wherein the structured first major surface has a positive focal length for at least one visible wavelength in a visible wavelength range extending from about 420 nm to about 680 nm.

16. The light control film of claim 1 further comprising a planarizing overcoat conformally covering, and substantially planarizing, the structured first major surface.

17. The light control film of claim 16, wherein a minimum average peel strength between the planarizing overcoat and the coating layer is greater than about 20 μm/inch.

18. The light control film of claim 16, wherein for a light incident on the light control film from a CIE Standard Illuminant D65, the light control film has an optical haze of less than about 30%.

19. The light control film of claim 16 further comprising a light transmissive body (10) comprising the structured first major surface and the opposite second major surface, and wherein for at least one visible wavelength in a visible wavelength range extending from about 420 nm to about 680 nm, a magnitude of a difference between indices of refraction of the light transmissive body and the planarizing overcoat is greater than about 0.05 and less than about 0.5.

20. A display system comprising the light control film of claim 1 disposed on a display configured to form an image, and a second light control film disposed between the light control film and the display, the second light control film comprising a plurality of alternating substantially light transmissive and light absorbing regions.
